(19) United States
(12) Patent Application Publication
(10) Pub. No.: US 2015/0027776 A1
(43) Pub. Date: Jan. 29, 2015

(54) Electric Wire Holding Structure

(71) Applicant: Yazaki Corporation, Minato-ku, Tokyo (JP)

(72) Inventor: Shingo Chiba, Makinohara-shi (JP)

(73) Assignee: Yazaki Corporation, Minato-ku, Tokyo (JP)

(21) Appl. No.: 14/384,921

(22) PCT Filed: Mar. 13, 2013
(86) PCT No.: PCT/JP2013/058177

§ 371 Date: Sep. 12, 2014

(30) Foreign Application Priority Data
Mar. 14, 2012 (JP) 2012-056743

(51) Int. Cl. H02G 1/00

(52) U.S. Cl. CPC H02G 1/00
USPC 174/70 R

(57) ABSTRACT

An electric wire holding structure includes an electric wire holder, an electric wire holder attached portion, and an engaging portion. The electric wire holder holds and arranges a part of a plurality of electric wire and includes a rotation shaft at one end in a direction perpendicular to an extending direction of the plurality of electric wires. The electric wire holder attached portion includes a shaft supporting portion which pivotally support the rotation shaft and a plurality of press contact terminals to which the electric wires are press contacted, and to which the electric wire holder is attached while being pivotally supported by the shaft supporting portions and being rotated. The engaging portion includes an convex engaging portion and a concave engaging portion or an engaging hole portion.

### TECHNICAL FIELD

The present invention relates to an electric wire holding structure in which a plurality of electric wires are press contacted to press contact terminals to be held.

### BACKGROUND ART

Traditionally, an electric wire holding structure, in which a plurality of electric wires are press contacted to press contact terminals to be held, includes an electric wire holder in which part of the plurality of electric wires are aligned and held, and an electric wire holder attached portion which is provided with the press contact terminals to which the electric wires are press contacted, and to which the electric wire holder is attached. When the electric wire holder is attached to the electric wire holder attached portion, the plurality of electric wires are press contacted to the press contact terminals and held in the electric wire holding structure. For example, in PTL 1, an electric wire holding structure is disclosed which can reduce the load necessary for pressure-connection even if a plurality of electric wires are press contacted to press contact terminals at the same time (for example, refer to PTL 1).

The electric wire holding structure described in the PTL 1 is so constructed that the plurality of electric wires are press contacted to the press contact terminals and held when an electric wire holder, in which part of the plurality of electric wires are aligned and held and which has rotation shafts at one end side in a direction perpendicular to the extending direction of the plurality of electric wires, and an electric wire attached portion, which are provided with a shaft supporting portion which pivotally supports the rotation shafts and the plurality of press contact terminals to which the electric wires are press contacted, and to which the electric wire holder is attached while the electric wire holder is pivotally supported by the shaft supporting portion and is rotated, are engaged with a convex engaging portion which the electric wire holder is provided with and a concave engaging portion which the electric wire attached portion is provided with at an attached position of the electric wire holder.

### CITATION LIST

### Patent Literature

PTL 1
JP-A-2011-113802

### SUMMARY OF INVENTION

### Technical Problem

However, for the electric wire holding structure described in the PTL 1, because there is a fitting gap between the convex engaging portion and the concave engaging portion, and the electric wire holder gets loose by vibration, as a result, there is a problem that the connection stability of the electric wires and the press contact terminals decreases.

The present invention is made in view of the above situation, and the object of the present invention is to provide an electric wire holding structure so that while the load necessary when a plurality of electric wires are press contacted to press contact terminals is lowered, the connection stability of the electric wires and the press contact terminals is prevented from decreasing.

### Solution to Problem

(1) According to an aspect of the invention, an electric wire holding structure includes an electric wire holder, an electric wire holder attached portion, and an engaging portion. The electric wire holder holds and arranges a part of a plurality of electric wire and includes a rotation shaft at one end in a direction perpendicular to an extending direction of the plurality of electric wires. The electric wire holder attached portion includes a shaft supporting portion which pivotally support the rotation shaft and a plurality of press contact terminals to which the electric wires are press contacted, and to which the electric wire holder is attached while being pivotally supported by the shaft supporting portions and being rotated. The engaging portion includes an convex engaging portion provided at one of the electric wire holder and the electric wire holder attached portion, and a concave engaging portion or an engaging hole portion which is provided at the other of the electric wire holder and the electric wire holder attached portion and with which the electric wire holder and the electric wire holder attached portion are engaged at an attached position of the electric wire holder. The plurality of electric wires are held by being press contacted to the press contact terminals when the electric wire holder and the electric wire holder attached portion are engaged with the engaging portion. The electric wire holder attached portion has an engaging wall which is raised from an attached surface to which the electric wire holder is attached and at which the convex engaging portion, the concave engaging portion or the engaging hole portion is formed. When the convex engaging portion is provided, the convex engaging portion is provided to be horizontally projected from the wall surface of the engaging wall. When the concave engaging portion is provided, the concave engaging portion is provided so that the wall surface of the engaging wall is horizontally caved. When the engaging hole portion is provided, the engaging hole portion is provided to horizontally penetrate the engaging wall. The electric wire holder attached portion has an electric wire holder abutting portion which is abutted with the surface of the electric wire holder which faces the attached surface when the electric wire holder is located at the attached position where the electric wire holder is attached to the electric wire holder attached portion.

(2) In the electric wire holding structure of (1), the shaft supporting portions includes a shaft receiving groove which includes groove formed so that the rotation shafts is inserted from above, and a shaft falling preventing and abutting surface which is abutted with the electric wire holder to regulate the upwards movement of the electric wire holder, and which prevents the electric wire holder from falling from the shaft receiving groove.

(3) In the electric wire holding structure of (2), the sections of the rotation shafts have a semi-circular shape. The shaft receiving grooves have narrow groove portions whose width is set so that the rotation shafts are inserted with straight line portions of the semi-circular sections facing the inner edges of the grooves, and wide groove portions whose width is enlarged so that stepped surfaces are horizontally formed at the lower ends of the narrow groove portions and the rotation shafts are rotated at the bottoms of the grooves so that the straight line portions face upwards. The shaft falling preventing and abutting surfaces are the stepped surfaces which are abutted with the surfaces forming the straight line portions of the rotation shafts when the electric wire holder is moved upwards.

### Advantageous Effects of Invention

For the electric wire holding structure of (1), when the electric wire holder is pivotally supported by the shaft supporting portions and rotated, the plurality of electric wires are press contacted to the press contact terminals, and the electric wire holder is located in the attached position where the electric wire holder has been attached to the electric wire holder attached portion, because the electric wire holder is biased upwards since the surface of the electric wire holder that faces the attached surface is abutted with the electric wire holder abutting portion, the fitting gap in the upwards/downwards direction that is produced when the convex engaging portion which is provided to be horizontally projected from the wall surface of the engaging wall, the concave engaging portion which is provided so that the wall surface of the engaging wall is horizontally caved, or the engaging hole portion, which is provided to horizontally penetrate the engaging wall, and the mating engaging portion of the electric wire holder are engaged becomes small, or disappears since the electric wire holder is biased upwards by the electric wire holder abutting portion. Therefore, while a wobble of the electric wire holder is prevented and as a result the load necessary when the plurality of electric wires are press contacted to the press contact terminals is lowered, the connection stability of the electric wires and the press contact terminals is prevented from decreasing.

For the electric wire holding structure of (2), while the rotation shafts are prevented from falling from the shaft receiving grooves by the shaft falling preventing and abutting surfaces, the electric wire holder is biased upwards since the surface of the electric wire holder that faces the attached surface is abutted with the electric wire abutting portion when the electric wire holder is located at the attached position where the electric wire holder has been attached to the electric wire holder attached portion. Therefore, because the gap between the electric wire holder and the shaft falling preventing and abutting surfaces becomes small, the effect of preventing a wobble of the electric wire holder is improved.

For the electric wire holding structure of (3), while the stepped surfaces function as the shaft falling preventing and abutting surfaces, the electric wire holder is biased upwards since the surface of the electric wire holder that faces the attached surface, is abutted with the electric wire holder abutting portion when the electric wire holder is located at the attached position where the electric wire holder has been attached to the electric wire holder attached portion. Therefore, because the gap between the surfaces which form the straight line portions of the rotation shafts and the stepped surfaces becomes small, the effect of preventing a wobble of the electric wire holder is improved.

### BRIEF DESCRIPTION OF DRAWINGS

FIG. 1 is an exploded perspective view of a lighting device in which an electric wire holding structure according to an embodiment of the present invention is incorporated.

FIG. 2 is a perspective view of the lighting device before an electric wire holder shown in FIG. 1 is attached.

FIG. 3 is an enlarged figure of an area around an electric wire holder attached portion shown in FIG. 2.

FIG. 4 is a top view of an area around the electric wire holder attached portion shown in FIG. 3.

FIG. 5 is an enlarged figure of the electric wire holder shown in FIG. 1.

FIG. 6 is a perspective view which shows a state before an upper holding portion of the electric wire holder shown in FIG. 1 is overlaid on a lower holding portion of the electric wire holder.

FIG. 7 is a top view which shows a state that the electric wire holder is attached to the electric wire holder attached portion shown in FIG. 4.

FIG. 8 is a side view of the electric wire holder and the electric wire holder attached portion shown in FIG. 7.

FIG. 9 is an A-A line sectional view of the electric wire holder and the electric wire holder attached portion shown in FIG. 7.

FIG. 10 is a B-B line sectional view of the electric wire holder and the electric wire holder attached portion shown in FIG. 7.

FIG. 11 is a figure, which is viewed from the right front, of a state that the electric wire holder is attached to the electric wire holder attached portion shown in FIG. 1.

FIG. 12 is an A-A line sectional view of the electric wire holder and the electric wire holder attached portion shown in FIG. 11.

FIG. 13 is an enlarged figure of an area around an engaging portion shown in FIG. 12.

FIGS. 14A to 14C are figures which show steps of setting four electric wires to the electric wire holder.

FIGS. 15A to 15D are figures which show steps of attaching the electric wire holder to the electric wire holder attached portion.

### DESCRIPTION OF EMBODIMENTS

Below, an embodiment of the electric wire holding structure according to the present invention is described in detail with reference to the figures.

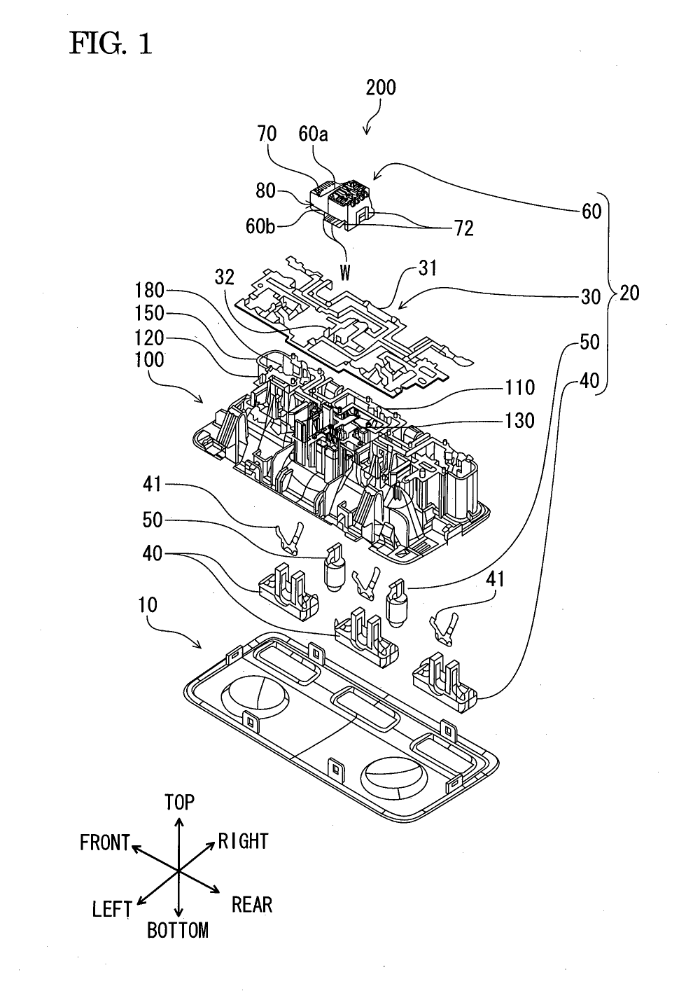

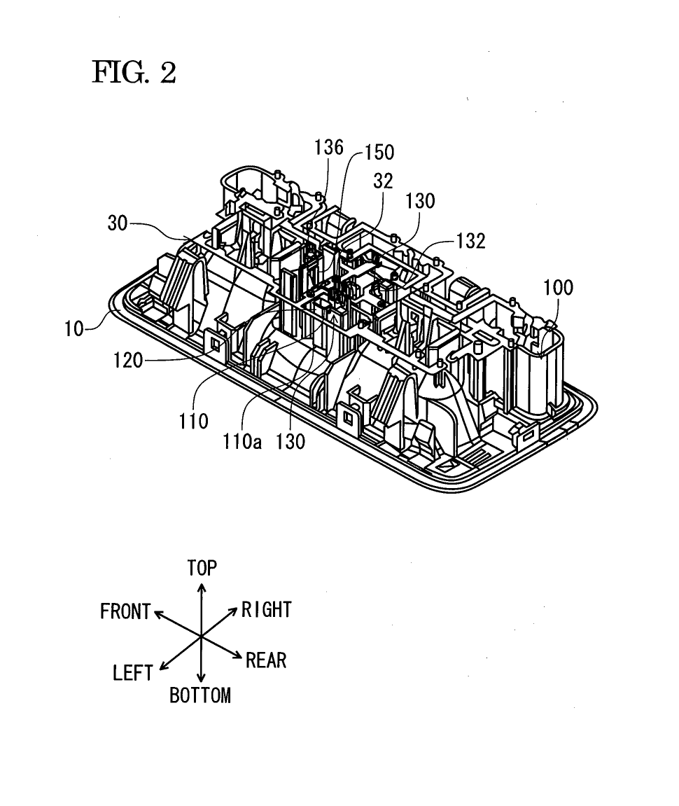

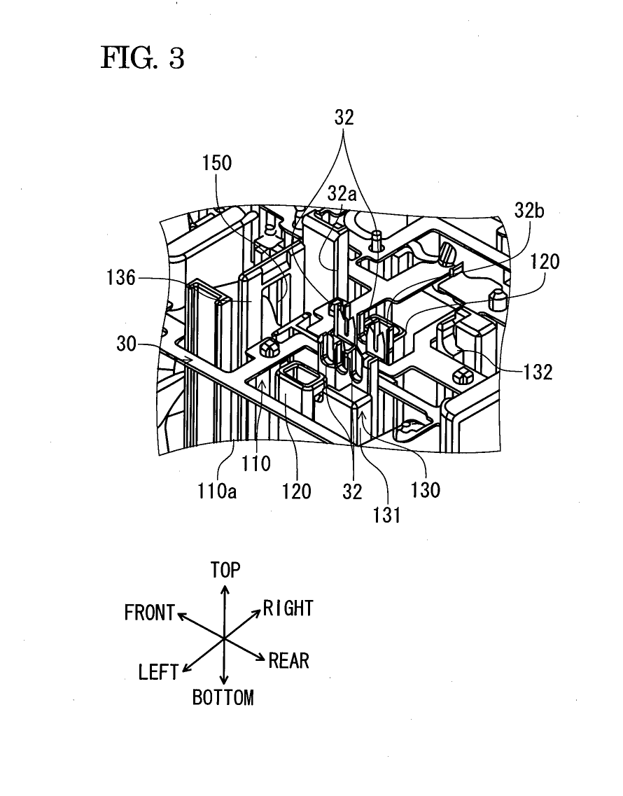

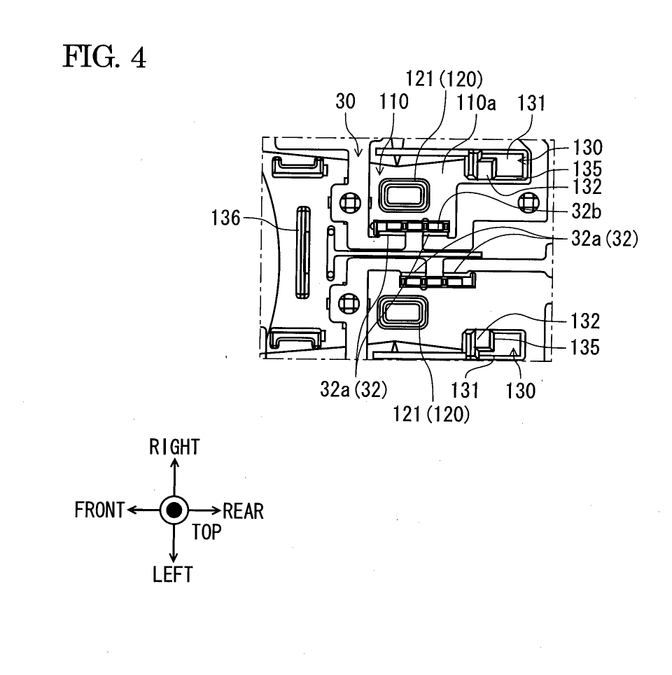

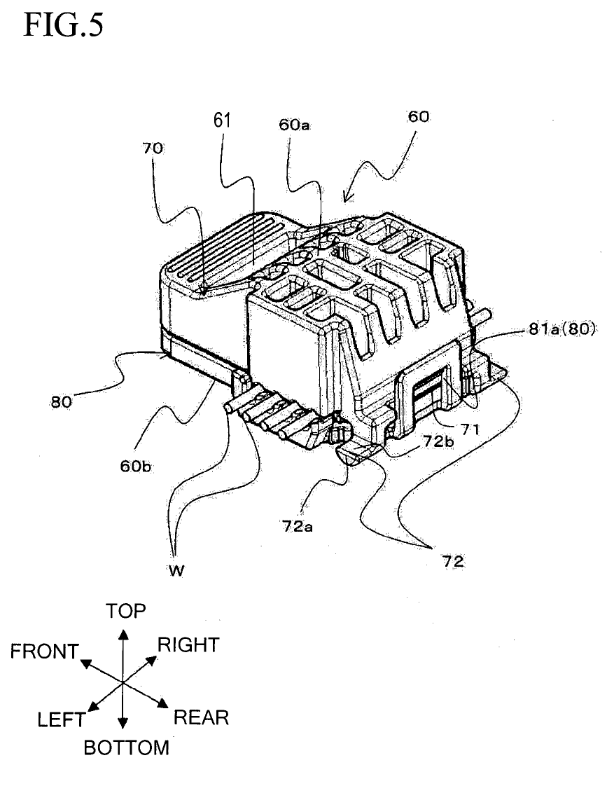

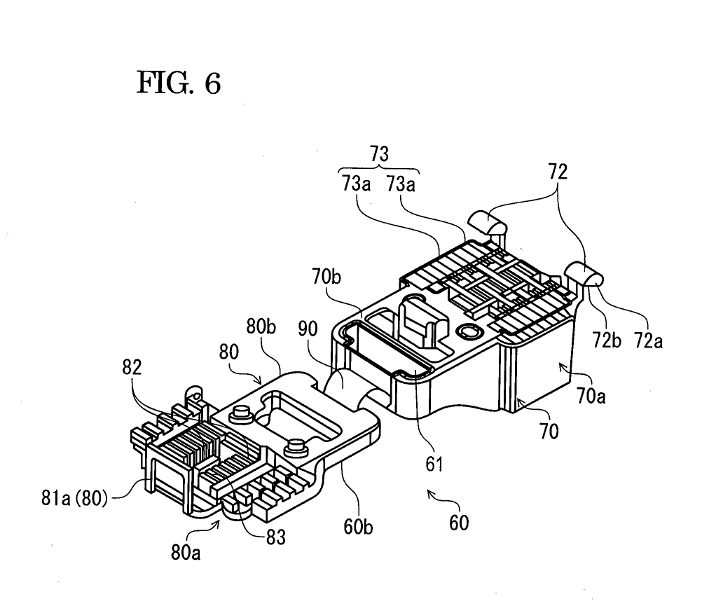

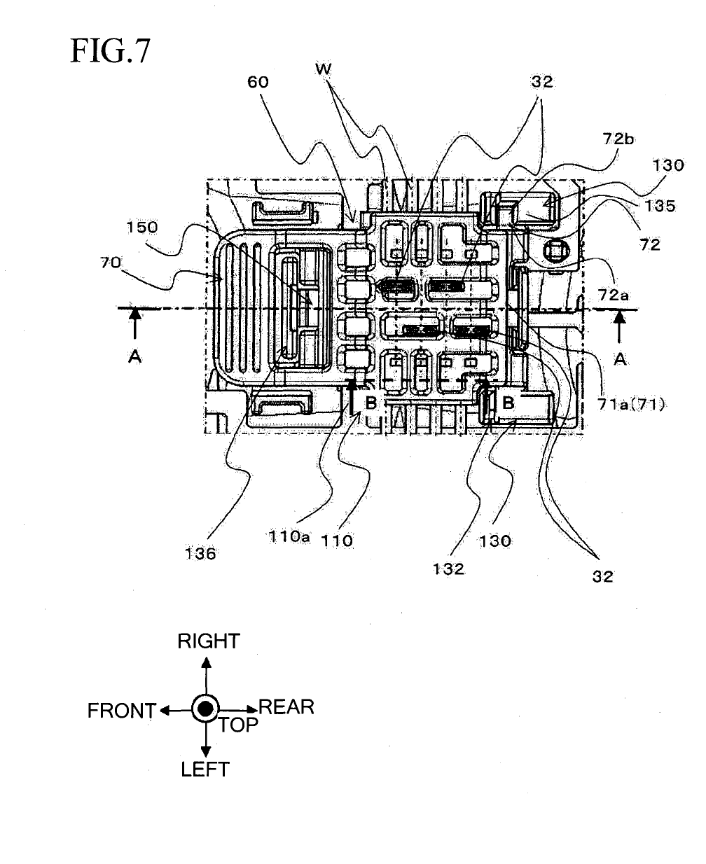

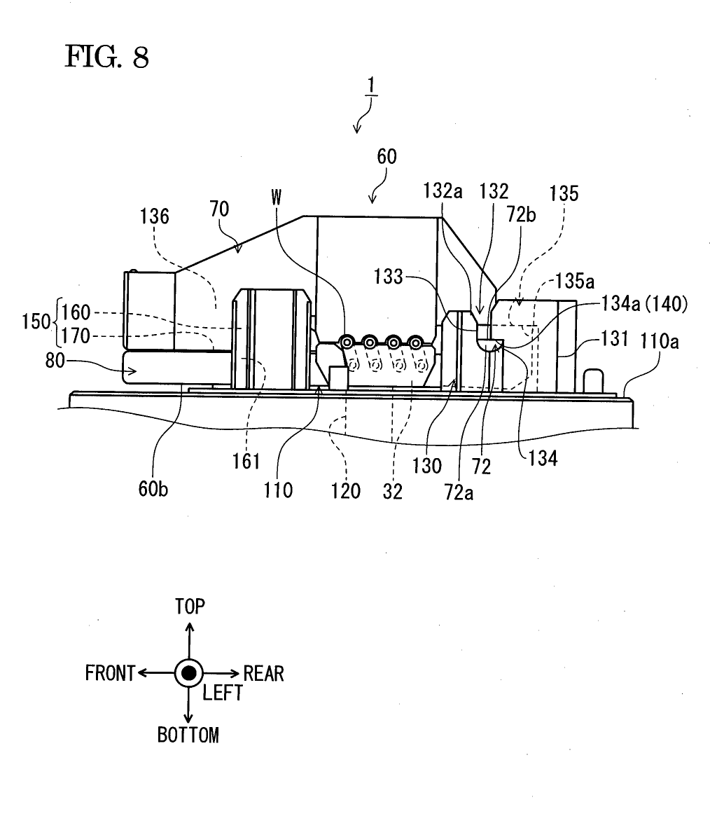

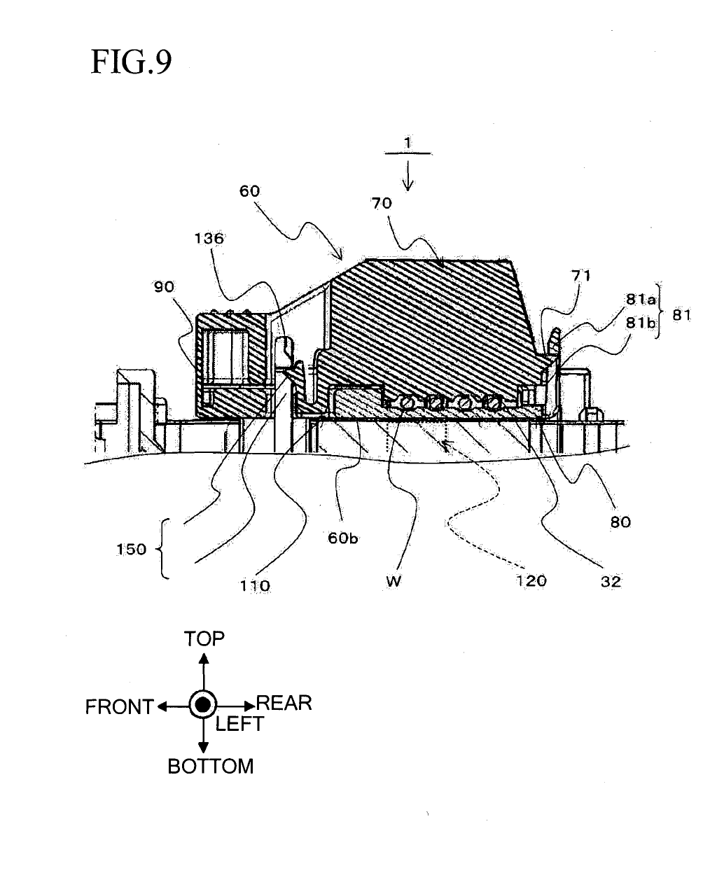

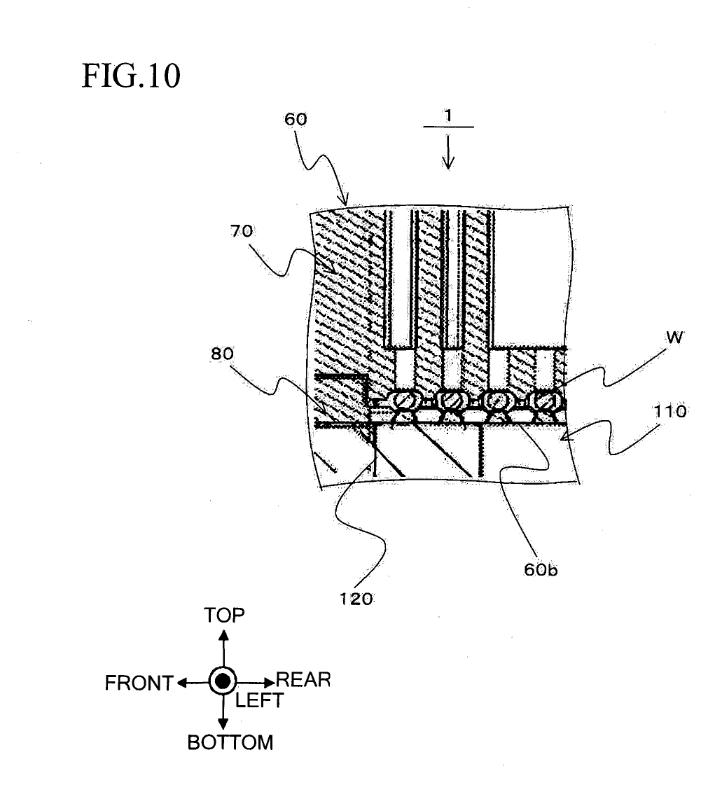

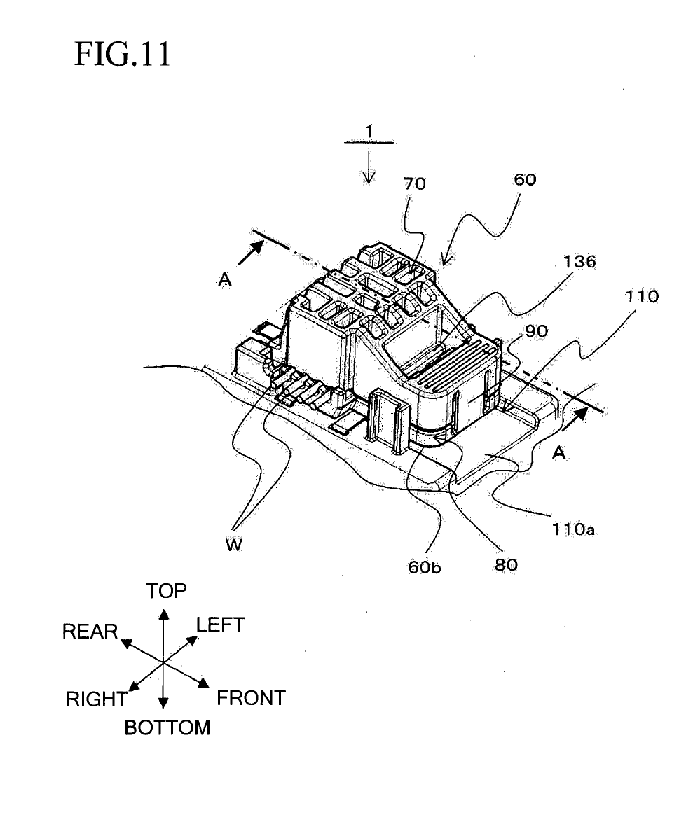

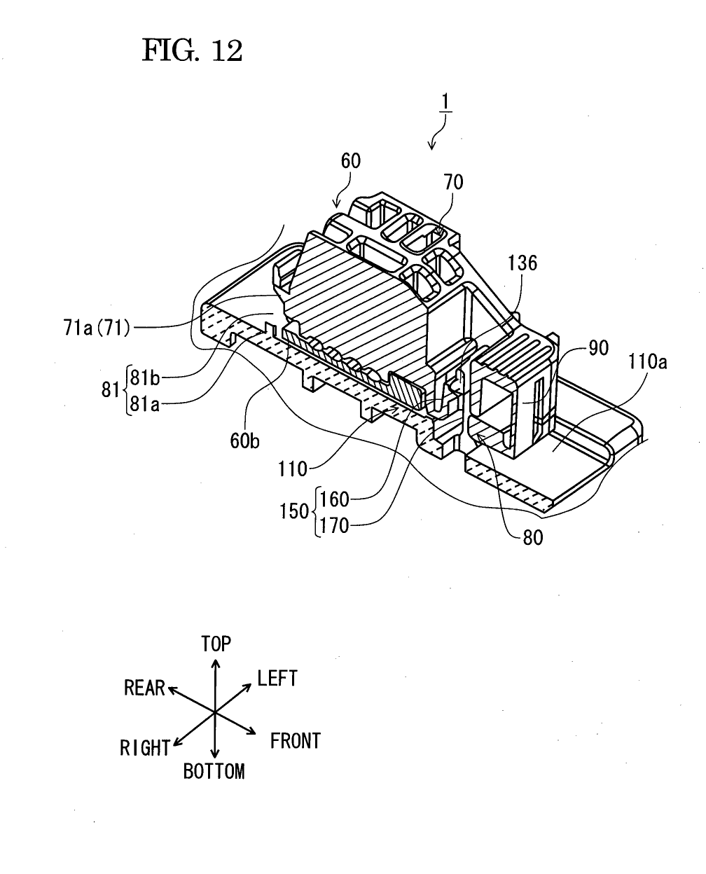

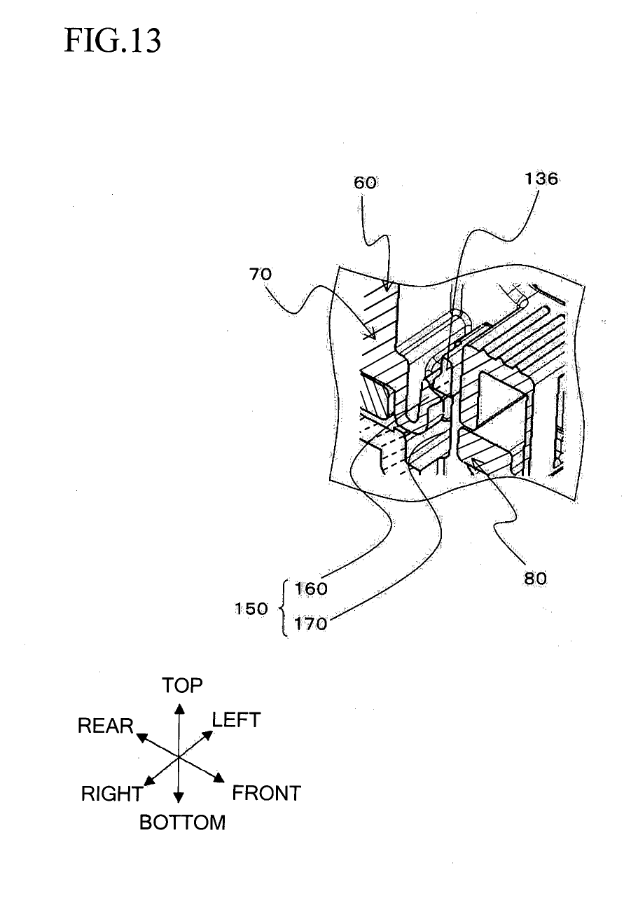

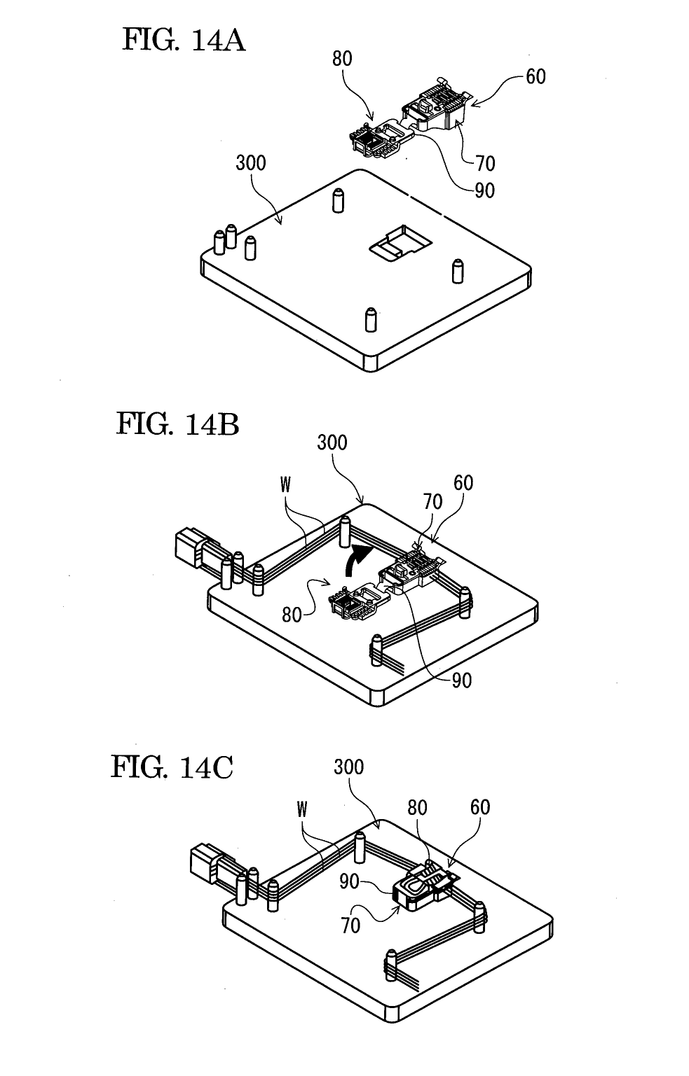

FIG. 1 is an exploded perspective view of a lighting device 200 in which an electric wire holding structure 1 according to an embodiment of the present invention is incorporated. FIG. 2 is a perspective view of the lighting device 200 before an electric wire holder 60 shown in FIG. 1 is attached. FIG. 3 is an enlarged figure of an area around an electric wire holder attached portion 110 shown in FIG. 2. FIG. 4 is a top view of an area around the electric wire holder attached portion 110 shown in FIG. 3. FIG. 5 is an enlarged figure of the electric wire holder 60 shown in FIG. 1. FIG. 6 is a perspective view which shows a state before an upper holding portion 70 of the electric wire holder 60 shown in FIG. 1 is overlaid on a lower holding portion 80 of the electric wire holder 60. FIG. 7 is a top view which shows a state that the electric wire holder 60 is attached to the electric wire holder attached portion 110 shown in FIG. 4. FIG. 8 is a side view of the electric wire holder 60 and the electric wire holder attached portion 110 shown in FIG. 7. FIG. 9 is an A-A line sectional view of the electric wire holder 60 and the electric wire holder attached portion 110 shown in FIG. 7. FIG. 10 is a B-B line sectional view of the electric wire holder 60 and the electric wire holder attached portion 110 shown in FIG. 7. FIG. 11 is a figure, which is viewed from the right front, of a state that the electric wire holder 60 is attached to the electric wire holder attached portion 110 shown in FIG. 1. FIG. 12 is an A-A line sectional view of the electric wire holder 60 and the electric wire holder attached portion 110 shown in FIG. 11. FIG. 13 is an enlarged figure of an area around an engaging portion 150 shown in FIG. 12. FIG. 14 is a figure which shows steps of setting four electric wires W to the electric wire holder 60.

For convenience, the directions of arrows in the figures are assumed as forwards/backwards, right-to-left/left-to-right, and upwards/downwards directions.

The electric wire holding structure 1 according to the embodiment of the present invention has the electric wire holder 60, the electric wire holder attached portion 110 and the engaging portion 150. Part of the four electric wires W are aligned and held in the electric wire holder 60, and the electric wire holder 60 has rotation shafts 72 at one end in the direction perpendicular to the extending direction of the four electric wires W. The electric wire holder attached portion 110 is provided with shaft supporting portions 130 which pivotally support the rotation shafts 72 and a plurality of press contact terminals 32 to which the electric wires W are press contacted. The electric wire holder 60 is pivotally supported by the shaft supporting portions 130, and is attached to the electric wire holder attached portion 110 while being rotated. At an attached position of the electric wire holder 60, the electric wire holder 60 and the electric wire holder attached portion 110 are engaged with the engaging portion 150 in a concave-convex mating way. When the electric wire holder 60 and the electric wire holder attached portion 110 are engaged with the engaging portion 150, the four electric wires W are press contacted to the press contact terminals 32, and are held.

For example, such an electric wire holding structure 1 is incorporated in the lighting device 200 arranged on the indoor ceiling of a vehicle.

The lighting device 200 has a lens 10, a lighting function portion 20, and a housing 100.

First, the lens 10 is described.

The external shape of the lens 10 is a rectangle, and the lens 10 collects light emitted from bulbs 50 which is the source of the light.

Next, the lighting function portion 20 is described.

The lighting function portion 20 has a busbar 30, a switch operation portion 40, the bulbs 50 and the electric wire holder 60.

The busbar 30 is a wiring member which is made by forging a conductive metal plate-like member to a circuit shape. The busbar 30 is attached to the housing 100 using welding pins or the like not shown in the figure.

The busbar 30 has a power supply terminal 31 and four press contact terminals 32 to which the four electric wires W are press contacted. As shown in FIGS. 3 and 4, each of the press contact terminals 32 has a press contact blade 32a in which a groove 32b is formed, When the electric wires W are pushed into the grooves 32b of the press contact blades 32a, insulation sheath (not shown in the figure) of the electric wires W is torn off, and exposed conductor parts are connected to the press contact blades 32a.

In this embodiment, it is exemplified that the number of the electric wires W is four, but the number of the electric wires W is not limited to four. The number of the press contact terminals 32 is also not limited, and is set according to the number of the electric wires W.

The switch operation portion 40 is an operation portion that changes operation modes (ON/FF) of the bulbs 50, and is attached to the housing 100.

Contacts 41 that are terminals are incorporated in the switch operation portion 40, when the contacts 41 are connected to the power supply terminal 31, a power supply operation is performed to the bulbs 50 in accordance with an operation mode of the switch operation portion 40.

Part of the four electric wires W are aligned and held in the electric wire holder 60, and when the electric wire holder 60 is attached to the electric wire holder attached portion 110 while being rotated, the four electric wires W are press contacted to the press contact terminals 32 at the same time.

As shown in FIGS. 5 and 6, in the electric wire holder 60, an upper holding portion 70 forming a holder top surface 60a of the electric wire holder 60 and a lower holding portion 80 forming a holder bottom surface 60b of the electric wire holder 60 are connected through a joint 90 which can be bent. The electric wire holder 60 is so formed that when the joint 90 is bent, the lower holding portion 80 is overlaid on the upper holding portion 70, and the four electric wires W are sandwiched between the upper holding portion 70 and the lower holding portion 80.

The upper holding portion 70 has an upper holding side engaging portion 71, the rotation shafts 72, and an upper holding side electric wire receiving portion 73. The upper holding side engaging portion 71 is a portion which is engaged with a lower holding side engaging portion 81 to be described below when the upper holding portion 70 is overlaid on the lower holding portion 80. The upper holding side engaging portion 71 has an convex engaging portion 71a which is projected from an end 70a at the side where the joint 90 is not provided among the ends of the upper holding portion 70 in the direction the electric wires W are paralleled.

The rotation shafts 72 are projected from two side parts near the end 70a at the side where the joint 90 is not provided among the ends of the upper holding portion 70 in the direction the electric wires W are paralleled. The rotation shafts 72 have a columnar shape which has a semi-circular cross section.

The upper holding side electric wire receiving portion 73 is a portion where the part of the four electric wires W are aligned and held, and has four electric wire receiving grooves 73a in which the electric wires W are embedded.

The lower holding portion 80 has a lower holding side engaging portion 81, a press contact blade penetrated portion 82, and a lower holding side electric wire receiving portion 83.

The lower holding side engaging portion 81 is a portion which is engaged with the upper holding portion side engaging portion 71 when the upper holding portion 70 is overlaid on the lower holding portion 80. The lower holding side engaging portion 81 has an engaging strip 81a which has a strip form and is raised from a surface 80b on which the upper holding portion 70 is overlaid at the position of an end 80a where the joint 90 is not provided among the ends of the lower holding portion 80 in the direction the electric wires W are paralleled, and an engaging hole 81b which is a through hole formed in the engaging strip 81a.

The press contact blade penetrated portion 82 has through holes which are formed in the lower holding portion 80 so that the press contact blades 32a can penetrate through the lower holding portion 80.

The lower holding side electric wire receiving portion 83 is a portion which maintains the four electric wires W in an aligned state and pushes the electric wires W into the electric wire receiving grooves 73a of the upper holding portion 70 when the upper holding portion 70 is overlaid on the lower holding portion 80 so that the four electric wires W are sandwiched between the upper holding portion 70 and the lower holding portion 80.

A through hole 61 for engagement, which is formed to pass through an engaging wall 136 to be described below, is formed, and when an convex engaging portion 160 which the electric wire holder 60 is provided with in the through hole 61 for engagement and an engaging hole portion 170 which the electric wire holder attached portion 110 is provided with are engaged, the electric wire holder 60 is fixed to the electric wire holder attached portion 110.

When the four electric wires W are set in such an electric wire holder 60, as shown in FIG. 14, a jig for supporting setting electric wires 300 which fixes the electric wire holder 60 and adjusts the position and tension of each of the electric wires W is used. An operator sets the electric wire holder 60 on the jig for supporting setting electric wires 300 (FIG. 14A), arranges the electric wires W into the entries of the electric wire receiving grooves 73a of the upper holding portion 70 (FIG. 14B), and bends the joint 90 so that the upper holding portion 70 is overlaid on the lower holding portion 80 (FIG. 14C). Thereby, the four electric wires W are set in the electric wire holder 60.

Next, the housing 100 is described.

The housing 100 is a base of the lighting device 200 to which the lens 10 and the lighting function portion 20 is attached.

The housing 100 has the electric wire holder attached portion 110 to which the electric wire holder 60 is attached.

The electric wire holder attached portion 110 is provided with a pair of shaft supporting portions 130 which pivotally support the rotation shafts 72 which are projected from two side portions of the electric wire holder 60 when the electric wire holder 60 is put between the pair of shaft supporting portions 130, and the above-mentioned four press contact terminals 32 to which the electric wires W are press contacted. The electric wire holder attached portion 110 is a portion whose shaft supporting portions 130 pivotally support the electric wire holder 60, and to which the electric wire holder 60 is attached while being rotated.

The shaft supporting portion 130 has shaft receiving walls 131 including walls which are raised from an attached surface 110a to which the electric wire holder 60 is attached, the shaft receiving grooves 132 including grooves which are formed so that the rotation shafts 72 can be inserted from above, shaft falling preventing and abutting surfaces 140 against which the electric wire holder 60 abuts to regulate the upwards movement of the electric wire holder 60, and which prevent the rotation shafts 72 from falling from the shaft receiving grooves 132, and an engaging wall 136 which is raised from the attaching surface 110a to which the electric wire holder 60 is attached, and in which the engaging hole portion 170 to be described below is formed.

As shown in FIG. 8, the shaft receiving groove 132 has a narrow groove portion 133 and a wide groove portion 134 so that the width of the groove changes from a narrow part to a wide part from the entry side 132a of the groove towards the inside of the groove.

The narrow groove portion 133 is a portion in which the width of the groove is about the radius of the rotation shafts which have a columnar shape whose cross section is semi-circular. With such a narrow groove portion 133, the rotation shaft 72 is adapted to be inserted with a straight line portion 72a of the semi-circular section shape towards the inside edge of the groove.

The wide groove portion 134 is a portion in which the width of the groove is enlarged until the terminal part of the groove so that a horizontal stepped surface 134a is formed at the lower end of the narrow groove portion 133. With such a wide groove portion 134, the rotation shaft 72 is adapted to be rotated at the terminal part of the groove to such a direction that the straight line portion 72a of the semi-circular section shape faces upwards.

The shaft falling preventing and abutting surface 140 has an undersurface 135a of an upper protruding wall 135 and the stepped surface 134a of the shaft receiving groove 132.

The upper protruding wall 135 is a wall which is provided to be protruded above the holder top surface 60a of the electric wire holder 60, and is so formed that the undersurface 135a of the upper protruding wall 135 is abutted with the holder top surface 60a when the electric wire holder 60 is moved upwards from the attached position.

The stepped surface 134a of the shaft receiving groove 132 is adapted to abut with a surface 72b forming the straight line portion 72a of the rotation shaft 72 when the electric wire holder 60 is moved upwards.

Next, the engaging portion 150 is described.

With respect to the engaging portion 150, the electric wire holder 60 and the electric wire holder attached portion 110 are engaged at the attached position of the electric wire holder 60 with the convex engaging portion 160 which the electric wire holder 60 is provided with and the engaging hole portion 170 which the electric wire holder attached portion 110 is provided with.

The convex engaging portion 160 is a portion which is projected from an elastic engaging strip 161. The elastic engaging strip 161 is projected into a strip shape from the hole border of the through hole 61 for engagement and the overlaid surface 70b of the upper holding portion 70, and is bent into a U shape in the through hole 61 for engagement.

The engaging hole portion 170 is formed so that engaging wall 136 is penetrated horizontally. Thus, when the convex engaging portion 160 is engaged with the horizontally penetrated engaging hole portion 170, there is a fitting gap in the upwards/downwards direction.

The electric wire holder attached portion 110 has an electric wire holder abutting portion 120 which abuts with the holder bottom surface 60b, which becomes a surface of the electric wire holder 60 that faces the attached surface 110a, when the electric wire holder 60 is located at the position where the electric wire holder 60 has been attached to the electric wire holder attached portion 110.

As shown in FIGS. 3 and 4, the electric wire holder abutting portion 120 includes a pair of pipe-like walls 121 which are raised from the attached surface 110a, and the upper edge surfaces of the pipe-like walls 121 abut with the holder bottom surface 60b of the electric wire holder 60 attached to the electric wire holder attached portion 110.

The electric wire holder abutting portion 120 functions to bias the electric wire holder 60 upwards by being abutted with the holder bottom surface 60b.

That is, because the electric wire holder 60 is biased upwards by the electric wire holder abutting portion 120 when the electric wire holder 60 and the electric wire holder attached portion 110 are engaged with the engaging portion 150, the convex engaging portion 160 is adapted to be moved upwards so that the fitting gap between the convex engaging portion 160 and the engaging hole portion 170 becomes small or even disappears.

When the electric wire holder 60 is biased upwards in this way by the electric wire holder abutting portion 120, the holder top surface 60a is adapted to be moved upwards so that the gap between the holder top surface 60a and the undersurface 135a of the upper protruding wall 135 becomes small.

Furthermore, the surface 72b forming the straight line portion 72a of the rotation shaft 72 is adapted to be moved upwards so that the gap between the surface 72b and the stepped surface 134a of the shaft receiving groove 132 becomes small.

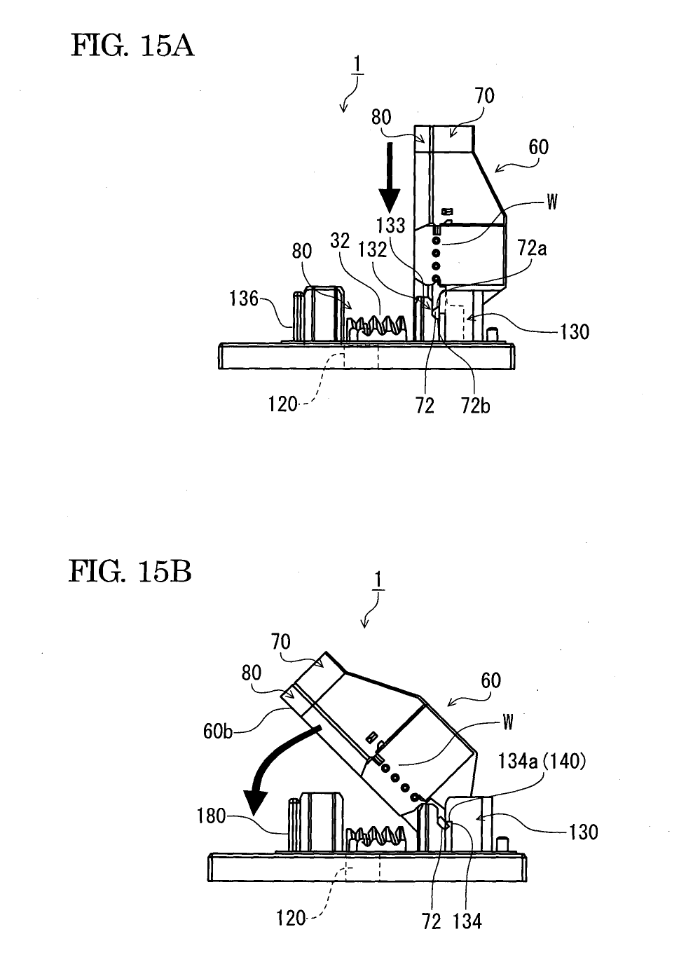

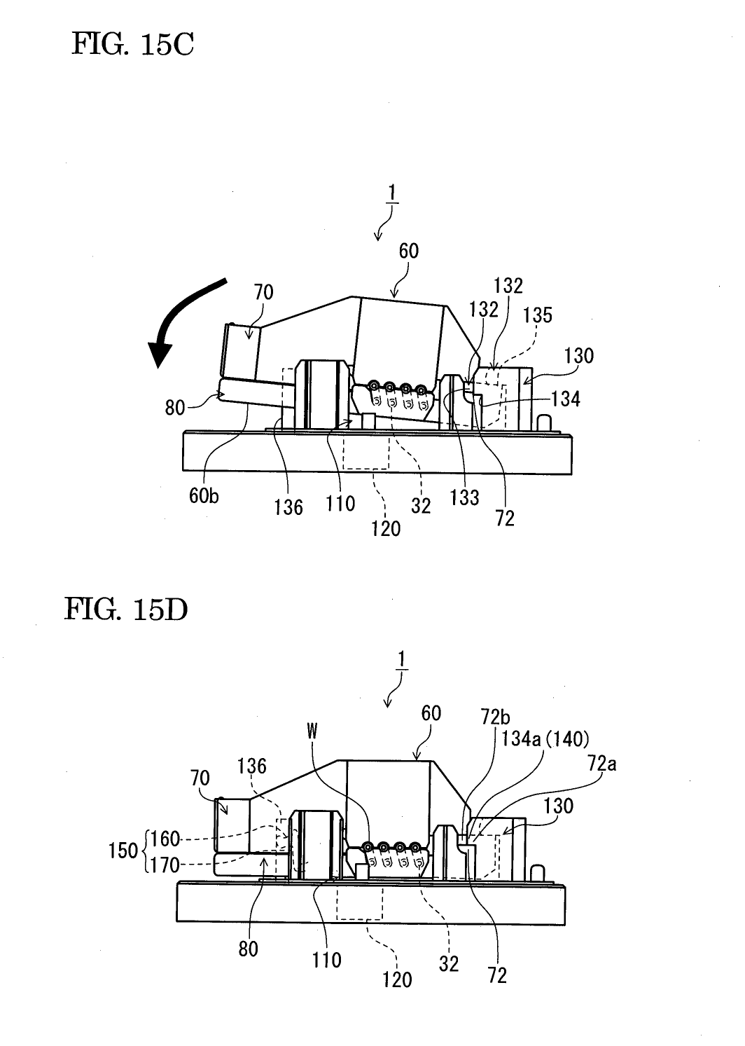

Steps of attaching the electric wire holder 60 to the electric wire holder attached portion 110 is described by using FIGS. 15 and 16. FIGS. 15 and 16 are figures which show the steps of attaching the electric wire holder 60 to the electric wire holder attached portion 110. First, an operator attaches the rotation shafts 72 of the electric wire holder 60 to the shaft supporting portions 130 (refer to FIG. 15A). When the rotation shafts 72 are inserted from the entries of the shaft receiving grooves 132 to be attached to the shaft supporting portions 130, the rotation shafts 72 are inserted with the straight line portions 72a facing the inner edges of the grooves. Therefore, the direction of the electric wire holder 60 is decided, and a false assembly of the electric wire holder 60 is prevented.

Then, the operator makes the electric wire holder 60 rotate around the rotation shafts 72 (refer to FIG. 15B). At this time, while the electric wire holder 60 is rotated, the four electric wires W are brought close to the press contact blades.

Then, when the operator makes the electric wire holder 60 further rotate, the electric wires W start to be press contacted to the press contact terminals (refer to FIG. 15C). At this time, when the electric wires W hit the press contact blades 32a, the surfaces 72b of the rotation shafts 72 are abutted with the stepped surfaces 134a due to an anti-force of the force with which the electric wires W are to be cut. Therefore, the stepped surfaces 134a become fulcrums in the principle of leverage, and the electric wires W are close to the fulcrums and can be easily press contacted.

Then, the operator makes the electric wire holder 60 further rotate, and when the electric wire holder 60 and the electric wire holder attached portion 110 are engaged with the engaging portion 150, the attaching of the electric wire holder 60 the electric wire holder attached portion 110 is completed (refer to FIG. 15D). Thereby, the electric wires W are held in a state of being press contacted to the press contact terminals 32a. Because the electric wire holder 60 is biased upwards since the holder bottom surface 60b is abutted with the electric wire holder abutting portion 120, the fitting gap between the convex engaging portion 160 and the engaging hole portion 170 becomes small or disappears, the gap between the holder top surface 60a and the undersurface 135a of the upper protruding wall 135 becomes small, and the gap between the surfaces 72b of the rotation shafts 72 and the stepped surfaces 134a of the shaft receiving grooves 132 becomes small.

When the electric wire holder 60 is raised upwards by the electric wire holder abutting portion 120 until the fitting gap between the convex engaging portion 160 and the engaging hole portion 170 disappears, because the force of the upper holding portion 70 and the lower holding portion 80 to hold the four electric wires is increased, the electric wire holding force of the electric wire holder 60 is increased.

For the electric wire holding structure 1 according to the embodiment of the present invention, when the electric wire holder 60 is pivotally supported by the shaft supporting portions 130 and rotated, the plurality of electric wires W are press contacted to the press contact terminals 32, and the electric wire holder 60 is located in the position where the electric wire holder 60 has been attached to the electric wire holder attached portion 110, because the electric wire holder 60 is biased upwards since the holder bottom surface 60b, which becomes a surface of the electric wire holder 60 that faces the attached surface 110a, is abutted with the electric wire holder abutting portion 120, the fitting gap in the upwards/downwards direction that is produced when the engaging hole portion 170, which is provided to horizontally penetrate the engaging wall 136, and the convex engaging portion 160 of the electric wire holder 60 are engaged becomes small, or disappears since the electric wire holder 60 is biased upwards by the electric wire holder abutting portion 120. Therefore, while a wobble of the electric wire holder 60 is prevented and as a result the load necessary when the plurality of electric wires W are press contacted to the press contact terminals 32 is lowered, the connection stability of the electric wires W and the press contact terminals 32 can be prevented from decreasing.

For the electric wire holding structure 1 according to the embodiment of the present invention, while the rotation shafts 72 are prevented from falling from the shaft receiving groove 132 by the shaft falling preventing and abutting surfaces 140, the electric wire holder 60 is biased upwards since the holder bottom surface 60b, which is a surface of the electric wire holder 60 that faces the attached surface 110a, is abutted with the electric wire holder abutting portion 120 when the electric wire holder 60 is located at the position where the electric wire holder 60 has been attached to the electric wire holder attached portion 110. Therefore, because the gap between the electric wire holder 60 and the shaft falling preventing and abutting surfaces 140 becomes small, the effect of preventing a wobble of the electric wire holder 60 can be improved.

For the electric wire holding structure 1 according to the embodiment of the present invention, while the stepped surfaces 134a function as the shaft falling preventing and abutting surfaces 140, the electric wire holder 60 is biased upwards since the holder bottom surface 60b, which is a surface of the electric wire holder 60 that faces the attached surface 110a, is abutted with the electric wire holder abutting portion 120 when the electric wire holder 60 is located at the position where the electric wire holder 60 has been attached to the electric wire holder attached portion 110. Therefore, because the gap between the surfaces 72b which form the straight line portions 72a of the rotation shafts 72 and the stepped surfaces 134a becomes small, the effect of preventing a wobble of the electric wire holder 60 can be improved.

In the electric wire holding structure 1 according to the embodiment of the present invention, it is exemplified that the engaging portion 150 include the convex engaging portion 160 which the electric wire holder is provided with and the engaging hole portion 170 which the electric wire holder attached portion 110 is provided with, and with which the electric wire holder 60 and the electric wire holder attached portion 110 are engaged at the attached position of the electric wire holder 60, but the invention is not limited to this. It is also possible that the electric wire holder 60 and the electric wire holder attached portion 110 are engaged at the attached position of the electric wire holder 60 with an convex engaging portion which is provided at one of the electric wire holder 60 and the electric wire holder attached portion 110, and a concave engaging portion or an engaging hole portion which is provided at the other of the electric wire holder 60 and the electric wire holder attached portion 110. When the electric wire holder attached portion 110 is provided with the convex engaging portion, the convex engaging portion is provided to be projected horizontally from the engaging wall 136, and when the electric wire holder attached portion 110 is provided with the concave engaging portion, the concave engaging portion is provided so that the wall surface of the engaging wall 136 is caved horizontally.

In the electric wire holding structure 1 according to the embodiment of the present invention, it is exemplified that the engaging portion 150 is provided at one place, but it is also possible that the engaging portion 150 is provided at a plurality of places.

In the electric wire holding structure 1 according to the embodiment of the present invention, it is exemplified that the section of the rotation shafts 72 has a semi-circular shape, but the invention is not limited to this and the section may have a circular shape.

In the electric wire holding structure 1 according to the embodiment of the present invention, it is exemplified that the electric wire holder abutting portion 120 includes a pair of pipe-like walls 121, but the invention is not limited to this. That is, other shapes, numbers and arrangements are possible as long as the electric wire holder abutting portion 120 is abutted with the holder bottom surface 60b of the electric wire holder 60 attached to the electric wire holder attached portion 110.

The invention accomplished by the inventor is described in detail based on the above embodiment of the invention, but the present invention is not limited to the above embodiment of the invention and can be modified in various ways without departing from the spirit of the invention.

The present application is based on Japanese Patent Application No. 2012-056743, filed on Mar. 14, 2012, the entire contents of which are incorporated herein by reference.

### INDUSTRIAL APPLICABILITY

There is provided an electric wire holding structure so that while the load necessary when a plurality of electric wires are press contacted to press contact terminals is lowered, the connection stability of the electric wires and the press contact terminals is prevented from decreasing.

### REFERENCE SIGNS LIST

1 electric wire holding structure
10 lens
20 lighting function portion
30 busbar
31 power supply terminal
32 press contact terminal
32a press contact blade
32b groove
40 switch operation portion
41 contact
50 bulb
60 electric wire holder
60a holder top surface
60b holder bottom surface
61 through hole for engagement
70 upper holding portion
70a end
70b overlaid surface
71 upper holding side engaging portion
71a convex engaging portion
72 rotation shaft
72a straight line portion
72b surface
73 upper holding side electric wire receiving portion
73a electric wire receiving grooves
80 lower holding portion
80a end
80b overlaid surface
81 lower holding side engaging portion
81a engaging strip
81b engaging hole
82 press contact blade penetrated portion
83 lower holding side electric wire receiving portion
90 joint
100 housing
110 electric wire holder attached portion
110a attached surface
120 electric wire holder abutting portion
121 pipe-like walls
130 shaft supporting portion
   131 shaft receiving wall
132 shaft receiving groove
133 narrow groove portion
134 wide groove portion
134a stepped surface
135 upper protruding wall
135a undersurface
136 engaging wall
140 shaft falling preventing and abutting surface
150 engaging portion
160 convex engaging portion
161 elastic engaging strip
170 engaging hole portion
200 lighting device
300 jig for supporting setting electric wires
W electric wires

1. An electric wire holding structure comprising:
an electric wire holder that holds and arranges a part of a plurality of electric wire and includes a rotation shaft at one end in a direction perpendicular to an extending direction of the plurality of electric wires;
an electric wire holder attached portion that includes a shaft supporting portion which pivotally support the rotation shaft and a plurality of press contact terminals to which the electric wires are press contacted, and to which the electric wire holder is attached while being pivotally supported by the shaft supporting portions and being rotated; and
an engaging portion that includes an convex engaging portion provided at one of the electric wire holder and the electric wire holder attached portion, and a concave engaging portion or an engaging hole portion which is provided at the other of the electric wire holder and the electric wire holder attached portion and with which the electric wire holder and the electric wire holder attached portion are engaged at an attached position of the electric wire holder,
wherein the plurality of electric wires are held by being press contacted to the press contact terminals when the electric wire holder and the electric wire holder attached portion are engaged with the engaging portion,
the electric wire holder attached portion has an engaging wall which is raised from an attached surface to which the electric wire holder is attached and at which the convex engaging portion, the concave engaging portion or the engaging hole portion is formed,
when the convex engaging portion is provided, the convex engaging portion is provided to be horizontally projected from the wall surface of the engaging wall,
when the concave engaging portion is provided, the concave engaging portion is provided so that the wall surface of the engaging wall is horizontally caved, and
when the engaging hole portion is provided, the engaging hole portion is provided to horizontally penetrate the engaging wall, and
the electric wire holder attached portion has an electric wire holder abutting portion which is abutted with the surface of the electric wire holder which faces the attached surface when the electric wire holder is located at the attached position where the electric wire holder is attached to the electric wire holder attached portion.

2. The electric wire holding structure according to claim 1, wherein the shaft supporting portions includes:
a shaft receiving groove which includes groove formed so that the rotation shafts is inserted from above, and
a shaft falling preventing and abutting surface which is abutted with the electric wire holder to regulate the upwards movement of the electric wire holder, and which prevents the electric wire holder from falling from the shaft receiving groove.

3. The electric wire holding structure according to claim 2, wherein the sections of the rotation shafts have a semi-circular shape,
the shaft receiving grooves have narrow groove portions whose width is set so that the rotation shafts are inserted with straight line portions of the semi-circular sections facing the inner edges of the grooves, and wide groove portions whose width is enlarged so that stepped surfaces are horizontally formed at the lower ends of the narrow groove portions and the rotation shafts are rotated at the bottoms of the grooves so that the straight line portions face upwards, and
the shaft falling preventing and abutting surfaces are the stepped surfaces which are abutted with the surfaces forming the straight line portions of the rotation shafts when the electric wire holder is moved upwards.
